(19) United States
(12) Patent Application Publication
(10) Pub. No.: US 2017/0147966 A1
(43) Pub. Date: May 25, 2017

(54) INVENTORY MONITORING SENSOR SYSTEM

(71) Applicant: Verizon Patent and Licensing Inc., Arlington, VA (US)

(72) Inventors: Luis E. Aversa, Doral, FL (US); Hector Saint-Hilaire, Waltham, MA (US); Manuel E. Ledesma, Lexington, MA (US)

(21) Appl. No.: 14/950,774

(22) Filed: Nov. 24, 2015

(51) Int. Cl. G06Q 10/08; G06K 7/14; H04N 7/18; G06Q 10/06

(52) U.S. Cl. CPC G06Q 10/087; G06Q 10/06315; G06Q 10/08355; G06K 7/1413; H04N 7/183

(57) ABSTRACT

A method includes receiving, at an inventory monitoring device and from a system including shelf inventory sensor devices that each include cameras and distance sensors positioned to monitor shelf spaces, camera image data and distance sensor data from the shelf inventory sensor devices. Types of items stored on shelf spaces and a number of items stored on the at shelf spaces are determined based on the camera image data. A current used volume of the shelf spaces is identified based on distance sensor data, and a notification is sent to a device associated with the supplier in response to a determination that the current used volume is lower than a predetermined threshold.

### BACKGROUND

Retailers are known to allocate space to vendors and suppliers for display of inventory or product associated with the supplier. For example, suppliers, such as food vendors associated with manufacturers, distributors and/or produce companies may pay slotting fees to retailers, such as supermarkets, in order to have products displayed on retailer shelf space (e.g., supermarket shelf space). The suppliers may want to ensure that rented space allocated to the suppliers is properly stocked at all times. In instances in which the allocated shelf spaces are underutilized (e.g., empty or partially full), the suppliers may miss out on sales opportunities. The probability of customer defection to competing manufacturers may also increase with the decreased availability of items.

There are different ways that suppliers may prevent underutilization of allocated shelf space, increase customer acquisition and/or ensure higher levels of customer retention. However, these ways are often costly in terms of rented space and/or man hours. For example, the suppliers may increase the rented space to hold more inventory and/or increase the delivery frequency to ensure that the shelves are properly stocked.

### BRIEF DESCRIPTION OF THE DRAWINGS

FIG. 1 is an exemplary network in which systems and/or methods described herein may be implemented;

FIG. 2 is a block diagram of exemplary components of a device that may correspond to one of the devices of FIG. 1;

FIG. 3 is a functional block diagram of the shelf inventory sensor device of FIG. 1;

FIG. 4 is a functional block diagram of the inventory management server of FIG. 1;

FIG. 5 depicts a functional block diagram of the monitor module of FIG. 4;

FIG. 6 depicts a functional block diagram of the analytics module of FIG. 4;

FIG. 7 depicts a functional block diagram of the dashboard module of FIG. 4; and

FIG. 8 is a flow chart of an exemplary process for managing inventory based on shelf inventory sensor data from one or more shelf inventory sensor devices according to an implementation described herein.

### DETAILED DESCRIPTION

The following detailed description refers to the accompanying drawings. The same reference numbers in different drawings may identify the same or similar elements. Also, the following detailed description is exemplary and explanatory only and is not restrictive of the invention, as claimed.

Systems and/or methods described herein may provide an inventory management system. The inventory management system may include an inventory management server which may receive shelf inventory sensor data from one or more shelf inventory sensor devices via a wireless network. The shelf inventory sensor devices may be positioned to collect shelf inventory sensor data for shelf spaces and inventory stored on the shelves in a retail or distribution storage location. The shelf inventory sensor data may include camera images of the inventory, distance information for the inventory and shelf space, the types and numbers of items stored on each shelf, a location of the shelves, available space and the time that the items are viewed or monitored. The inventory management system may be used in warehouses, retail stores and any type of storage or display space within a confined area (e.g., supermarkets, home pantries, garage storage area, etc.).

The shelf inventory sensor devices may be grouped together in a shelf inventory monitoring strip or may be implemented as stand-alone devices. The shelf inventory sensor devices, whether grouped in shelf inventory monitoring strips of stand-alone, may be affixed to the shelves at a position to collect visual and other data (i.e., at a place, such as the top of the shelf overlooking the items, from which camera images and distance sensor data may be collected). Each of the shelf inventory sensor devices may include distance sensors, cameras and an associated shelf inventory controller that may connect to the inventory management server via the wireless network. A shelf inventory controller may be incorporated in each shelf inventory sensor device or may serve a single shelf inventory strip or multiple shelf inventory strips, which may be connected wirelessly or via a wired connection.

The shelf inventory sensor devices may obtain information regarding the current stock on each shelf The information may include shelf inventory sensor data, such as video (and/or still) images of monitored items, a store's location, a location of the shelf within the store's floor plan, identification of particular items, the number of each set of items, available shelf space, a duration that items have been stored at the location, etc. The shelf inventory controller may notify inventory managers (e.g., supermarket's vendors/suppliers) of low inventory on the allocated shelf spaces.

The inventory management server may support a dashboard application that includes a graphical user interface (GUI) on devices associated with suppliers. The dashboard application may enable suppliers to monitor inventory via the shelf inventory sensor devices. The inventory management server may process the shelf inventory sensor data and notify the suppliers systems (e.g., food manufacturers' systems) and the dashboard application of particular variances in the data. In some implementations, inventory management server may facilitate interaction between the dashboard application and the supplier's systems, for example to schedule and route shipments, and coordinate production and/or replenishment of stock. Inventory management server may provide business analytics of product demand via the dashboard application to devices associated with inventory suppliers.

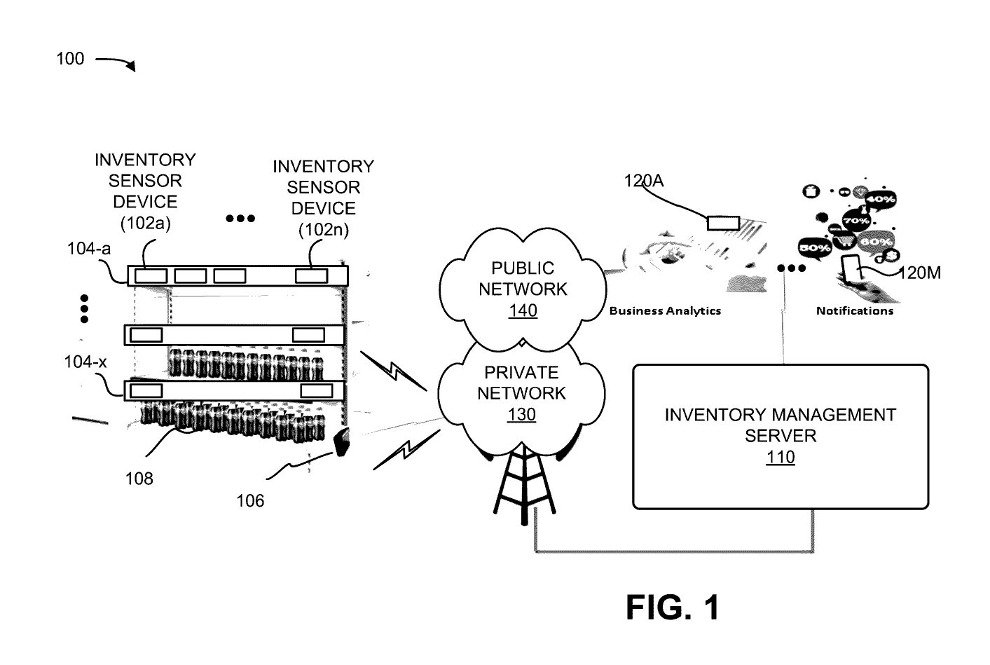

FIG. 1 is an exemplary network 100 in which systems and/or methods described herein may be implemented. As illustrated, network 100 may include a plurality of shelf inventory sensor devices 102a-102n (respectively shelf inventory sensor device 102a, to 102n, collectively referred to as shelf inventory sensor devices 102 or individually as shelf inventory sensor device 102), an inventory management server 110, a user device 120 (respectively user device 120a, to 120m, collectively referred to as user devices 120 or individually as user device 120), a private network 130, and a public network 140. The particular arrangement and number of components of network 100 shown in FIG. 1 are illustrated for simplicity. In practice there may be more shelf inventory sensor devices 102, inventory management servers 110, user devices 120 and/or networks 130/140. Components of network 100 may be connected via wired and/or wireless links.

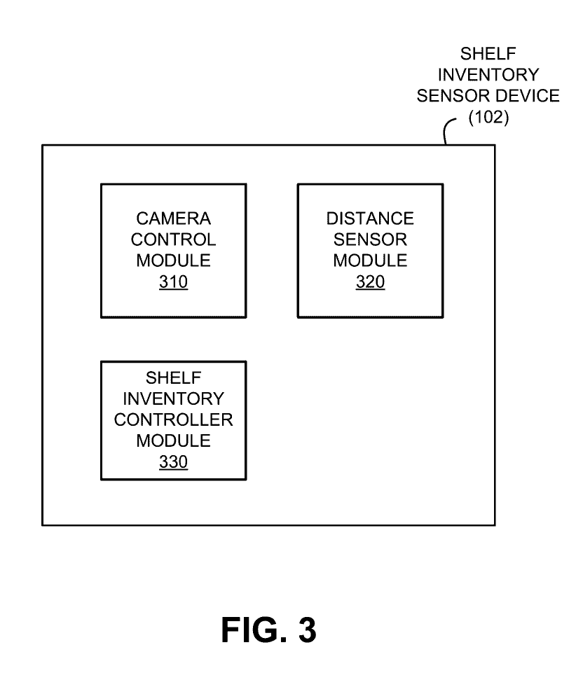

As described herein, each shelf inventory sensor device 102 may include a device that monitors inventory stored on shelves (or other confined storage areas, such as a bin, compartment, etc.) via cameras and a digital sensor, such as described with respect to FIG. 3 herein below. Shelf inventory sensor device 102 may include one or more cameras positioned and oriented in a manner to allow visual monitoring of inventory on shelves. Shelf inventory sensor device 102 may transmit shelf inventory sensor data to inventory management server 110. The shelf inventory sensor data may include data that allows monitoring of the inventory stored on a particular shelf, such as video (and/or still) images of monitored items, distance information, location information for the items, identification of particular items, the number of each set of items, available shelf space, a duration that items have been stored at the location, etc. The distance information may include distance of the items relative to the shelf inventory sensor device 102, distances between items on the shelf and/or distances across the shelf. In some instances, the shelf inventory sensor data may include temperature measured by an associated thermometer. These measurements may be provided to user devices 120 associated with suppliers in an ongoing manner and/or at particular regular intervals.

A group of shelf inventory sensor devices 102 may be arranged in a shelf inventory monitoring strip 104 that may be positioned in relation to the monitored inventory items 108. The shelf inventory sensor devices 102 may be arranged at different positions on shelves relative to the monitored inventory items 108, such as on the ceiling of the shelf above the items 108, at the outside border of the shelf, or the back of the shelf. For example, the shelf inventory sensor devices 102 may be distributed evenly in a linear manner along the shelf inventory monitoring strip 104 or multiple parallel groups of shelf inventory sensor devices 102 (without a shelf inventory monitoring strip 104) may be placed on each shelf. Shelf inventory sensor devices 102 on a particular shelf inventory monitoring strip 104 may share an electrical supply and/or communication line (e.g., wired together as a single multi-sensor device). A group of shelf inventory sensor devices 102 may be attached to (or include) a shelf controller 106 that reads shelf inventory sensor data from the shelf inventory sensor devices 102 (i.e., distance sensors and cameras) and transmits the shelf inventory sensor data via the wireless network 130/140 to inventory management server 110 and/or user devices 120.

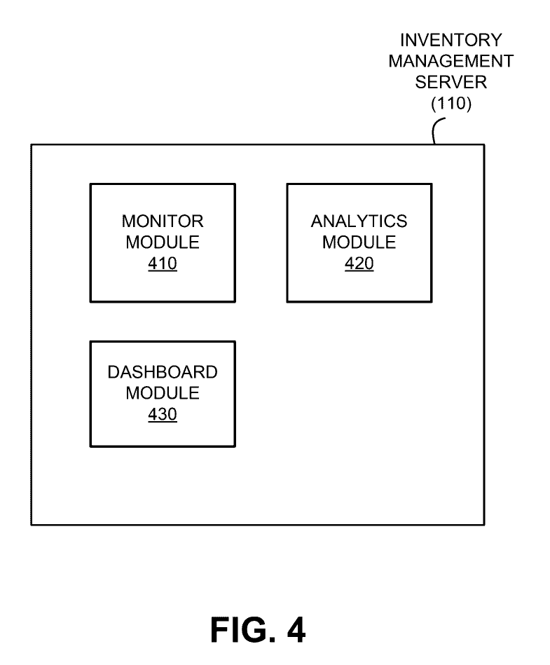

Inventory management server 110 may collect (e.g., request and/or receive) shelf inventory sensor data from shelf inventory sensor devices 102. Inventory management server 110 may allow the inventory suppliers to monitor inventory and generate and access business analytics of inventory rate of sales and demand via user devices 120, such as described herein below with respect to FIGS. 4 to 8. Inventory management server 110 may send notifications to user devices 120 associated with a supermarket's vendors/suppliers regarding low inventory on rented shelf space assigned to the suppliers. Inventory management server 110 may provide real time information of item numbers, projected consumption, and relative demand that may enable suppliers to properly restock products to avoid missed sales opportunities and to improve customer retention.

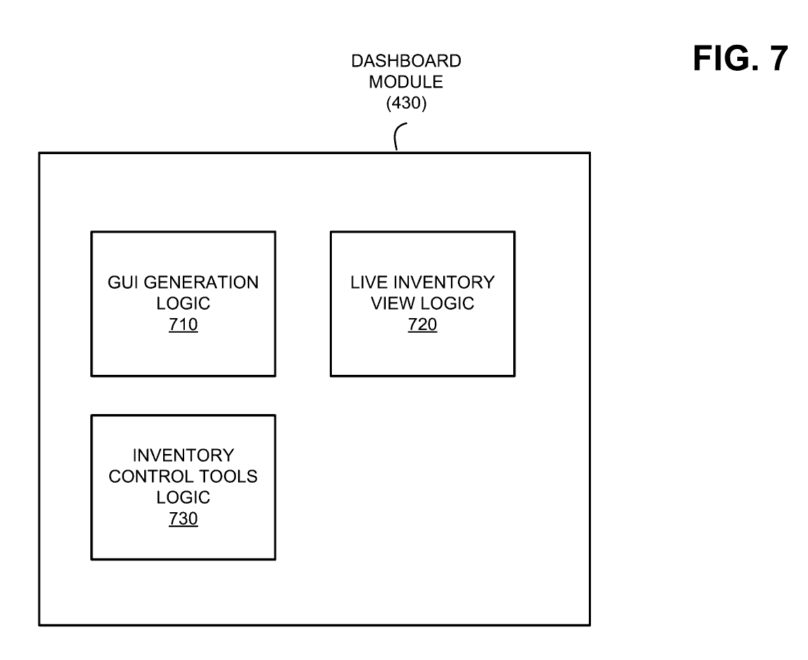

User device 120 may provide a graphical user interface (GUI) in which a dashboard for inventory monitoring and management, supported by a dashboard application, may be displayed. The dashboard application may provide a capability for an inventory supplier to monitor and analyze inventory via inventory management server 110 and/or shelf inventory sensor devices 102, such as described below with respect to FIG. 7. The dashboard may provide the ability to view live video (i.e., camera views from shelf inventory sensor devices 102) as well as archived video and images of the inventory items 108 which may be stored on user device 120 and/or inventory management server 110. The dashboard may also receive alerts in instances of a restocking event. The dashboard application may include multiple components and capabilities for monitoring inventory, analyzing demand for inventory and coordinating movement of inventory. The dashboard application may provide a store location, a position in the store floor plan in which the shelf is located, numbers of inventory, bar codes, product descriptions associated items 108, available space on the shelf (e.g., in cubic inches), sell by dates, etc.

User device 120 may include a cellular telephone, a smart phone, a laptop computer, a personal computer, a tablet computer, a wearable computer (e.g., a smart watch), or other types of computation or communication devices. In an exemplary implementation, user device 120 may include any device that is capable of communicating over networks 130/140 and displaying a GUI that includes inventory management information to an end user.

Private network 130 may include, for example, one or more private IP networks that use a private Internet protocol (IP) address space. Private network 130 may include a local area network (LAN), an intranet, a private wide area network (WAN), etc. In one implementation, private network 130 may implement one or more Virtual Private Networks (VPNs) for providing communication between, for example, any of shelf inventory sensor devices 102, inventory management server 110 and user device 120. Private network 130 may be protected/separated from other networks, such as public network 140, by a firewall. Although shown as a single element in FIG. 1, private network 130 may include a number of separate networks.

Public network 140 may include a local area network (LAN), a wide area network (WAN), such as a cellular network, a satellite network, a fiber optic network, a private WAN, or a combination of the Internet and a private WAN, etc. that is used to transport data. Although shown as a single element in FIG. 1, public network 140 may include a number of separate networks that function to provide communication between shelf inventory sensor devices 102, inventory management server 110 and user devices 120.

In implementations described herein, a system for managing inventory may be implemented based on shelf inventory sensor devices, inventory management servers, and user devices associated with inventory suppliers. The system may monitor inventory on retail and storage shelves and allow the inventory suppliers to analyze inventory movement, distribution and sales and to maximize the utilization of allocated retail spaces (e.g., rented supermarket shelves) based on supplier defined goals, such as immediate inventory turnover, introduction of new products, customer loyalty, etc. The inventory management system may allow inventory suppliers to properly restock products to avoid missed sales opportunities and reduce distribution cost.

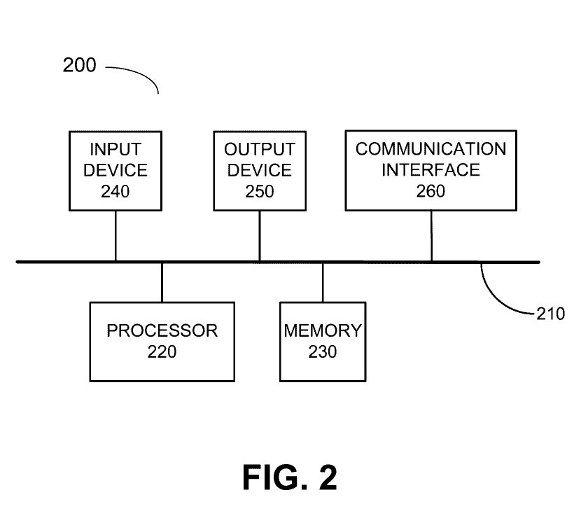

FIG. 2 is a diagram illustrating exemplary components of a device 200 (or devices) that may correspond to shelf inventory sensor device 102, inventory management server 110, and/or user device 120, as described in FIG. 1 above. As shown in FIG. 2, device 200 may include a bus 210, a processor 220, a memory 230, an input device 240, an output device 250, and a communication interface 260.

Bus 210 may include a path that permits communication among the components of system 100. Processor 220 may include any type of single-core processor, multi-core processor, microprocessor, latch-based processor, and/or processing logic (or families of processors, microprocessors, and/or processing logics) that interprets and executes instructions. In other embodiments, processor 220 may include an application-specific integrated circuit (ASIC), a field-programmable gate array (FPGA), and/or another type of integrated circuit or processing logic.

Memory 230 may include any type of dynamic storage device that may store information and/or instructions, for execution by processor 220, and/or any type of non-volatile storage device that may store information for use by processor 220. For example, memory 230 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Although input device 240 and output device 250 are shown, the input and output of system 100 may be through any device/API/protocol communication/or protocol enhancement.

Input device 240 may allow an operator to input information into system 100. Input device 240 may include, for example, a keyboard, a mouse, a pen, a microphone, a remote control, an audio capture device, an image and/or video capture device, a touch-screen display, and/or another type of input device. In some embodiments, system 100 may be managed remotely and may not include input device 240. In other words, system 100 may be “headless” and may not include a keyboard, for example.

Output device 250 may output information to an operator of system 100. Output device 250 may include a display, a printer, a speaker, and/or another type of output device. For example, device 200 may include a display, which may include a liquid-crystal display (LCD) for displaying content to the operator. In some embodiments, system 100 may be managed remotely and may not include output device 250. In other words, device 200 may be “headless” and may not include a display, for example.

Communication interface 260 may include a transceiver that enables system 100 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 260 may include a transmitter that converts baseband signals to radio frequency (RF) signals and/or a receiver that converts RF signals to baseband signals. Communication interface 260 may be coupled to an antenna for transmitting and receiving RF signals.

As described herein, device 200 may perform certain operations in response to processor 220 executing machine-readable instructions contained in a computer-readable medium, such as memory 230. A computer-readable medium may be defined as a non-transitory memory device. A memory device may include space within a single physical memory device or spread across multiple physical memory devices. The machine-readable instructions may be read into memory 230 from another computer-readable medium or from another device via communication interface 260. The machine-readable instructions contained in memory 230 may cause processor 220 to perform processes described herein. Alternatively, hardwired circuitry may be used in place of or in combination with machine-readable instructions to implement processes described herein. Thus, implementations described herein are not limited to any specific combination of hardware circuitry and software.

FIG. 3 is a functional block diagram of shelf inventory sensor device 102. Shelf inventory sensor device 102 may include a camera control module 310, a distance sensor module 320, and a shelf inventory controller module 330. The configuration of components of shelf inventory sensor device 102 illustrated in FIG. 3 is for illustrative purposes only. Other configurations may be implemented. Therefore, shelf inventory sensor device 102 may include additional, fewer and/or different components than those depicted in FIG. 3.

Shelf inventory sensor device 102 may include distance sensing components (e.g., machine readable instructions and/or physical components, such as an infrared (IR) distance detector) and camera components (e.g., a digital camera) that are assembled in a manner to allow monitoring of inventory on a shelf. Shelf inventory sensor device 102 may include a casing that may be affixed (or fastened/positioned) with a shelf inventory monitoring strip 140 (or individually) on the shelf at a position to monitor shelf inventory.

Camera control module 310 may control cameras (e.g., digital video cameras) that may be used to obtain visual information of inventory stored on each shelf. Camera control module 310 may include machine readable instructions that allow lens adjustment and (in some instances) control of servomotors that may allow repositioning of the camera, the lens within the camera housing, and/or the entire shelf inventory sensor device 102 along a shelf inventory monitoring strip 104 (e.g., via an associated servomotor).

Distance sensor module 320 may monitor distances within the shelf area including a distance between the shelf inventory sensor device 102 and inventory items 108. Distance sensor module 320 may read distance sensor information and compile the distance sensor information with pictures of the shelf collected by camera control module 310. Distance sensor module 320 may include a proximity sensor such as a thermal, infrared, sonar, or other sensor. Distance sensor module 320 may, in conjunction with camera control module 310 and inventory management server 110, determine available space within the shelf area. The available space may be measured based on volumes within which additional items may be positioned (e.g., in square inches or square centimeters, etc.).

Shelf inventory controller module 330 may include machine-readable instructions that control a single shelf inventory sensor device 102 or alternatively a group of shelf inventory sensor devices 102 (e.g., a group of shelf inventory sensor devices 102 that are arranged in a shelf inventory monitoring strip(s) 104 on a particular shelf (or particular shelves)). Shelf inventory controller module 330 may communicate with inventory management server 110 to receive instructions and transmit collected shelf inventory sensor data. Shelf inventory controller module 330 may receive camera images collected by camera control module 310. Shelf inventory controller module 330 may collect pictures of the shelf and use a wireless network 130/140 to upload the pictures to the inventory management server. Shelf inventory controller module 330 may collect distance sensor data (e.g., vertical and horizontal distances) for spatial analysis that may be used by inventory management server 110 to determine cubic areas within the shelf area.

Shelf inventory controller module 330 may compile the information from the sensors and cameras into shelf inventory sensor data and use the network(s) 130/140 to transmit the shelf inventory sensor data to inventory management server 110 and user devices 120 associated with suppliers (e.g., over a cloud based infrastructure). Shelf inventory controller module 330 may perform image analysis, such as item recognition, prior to sending the camera image data to inventory management server 110.

According to an embodiment, shelf inventory sensor device 102 (or shelf inventory monitoring strip 104) may include a visual indicator or display, such as a light emitting diode (LED). Shelf inventory controller module 330 may provide a visual indication based on thresholds or communication from user devices 120 and/or inventory management server 110. For example, an LED may blink in response to inventory levels decreasing below a predetermined threshold or based on a signal from a user device 110 associated with a supplier (e.g., in instances in which supplier personnel are delivering items).

FIG. 4 is a functional block diagram of inventory management server 110. Inventory management server 110 may include monitor module 410, analytics module 420, and dashboard module 430. The configuration of components of inventory management server 110 illustrated in FIG. 4 is for illustrative purposes only. Other configurations may be implemented. Therefore, inventory management server 110 may include additional, fewer and/or different components than those depicted in FIG. 4.

Inventory management server 110 may be located in a provider network (e.g., private network 130) and may interact with user device 120 and shelf inventory sensor devices 102 via a wireless network 140. Inventory management server 110 may store and analyze the shelf inventory sensor data (including pictures and distance sensor information) to determine the types, numbers and percentage of inventory on each shelf relative to other items and/or total volume.

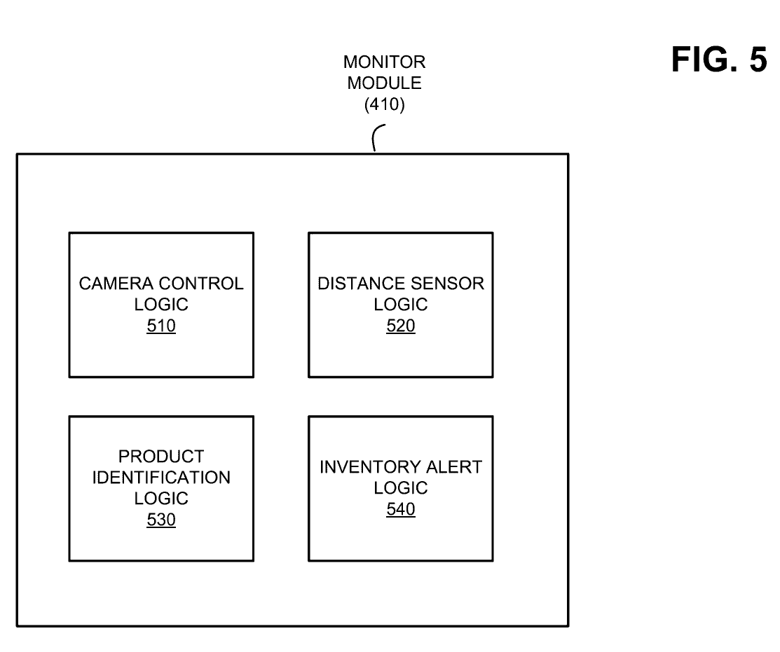

Monitor module 410 may perform real-time monitoring of inventory storage shelves (e.g., supermarket shelves) and stored items or products, such as described herein below with respect to FIG. 5. Monitor module 410 may determine the location and availability of products at locations within a supplier's system in which the shelf inventory sensor devices 102 may be deployed, such as retail locations, distribution storage locations and in transit locations. Monitor module 410 may store and analyze the pictures and sensor data to determine the numbers and percentage of inventory on the shelves at each location. Monitor module 410 may process the data and notify user devices 120 associated with suppliers (e.g., the food manufacturers systems).

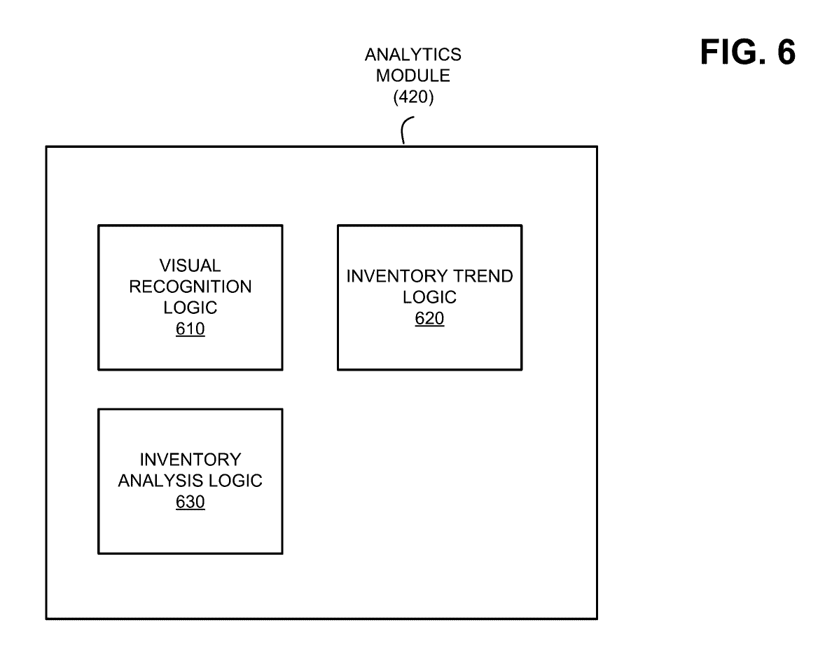

Analytics module 420 may perform trend analysis of product availability to optimize distribution cost and rented shelf space, such as described herein below with respect to FIG. 6. Analytics module 420 may perform analysis of shelf inventory sensor data over time. Analytics module 420 may enable suppliers to properly restock their products to avoid missed sales opportunities, improve customer retention and reduce distribution cost.

Dashboard module 430 may support inventory management on user devices 120 via a dashboard application, such as described herein below with respect to FIG. 7. Dashboard module 430 may allow the user to request the dashboard application and support downloads to associated user devices 120. Dashboard module 430 may support dashboard functionality, such as video streams from shelf inventory sensor devices 102, via a GUI displayed in user devices 120. Dashboard module 430 may also support data analysis by users via user devices 120 and communication with other devices and systems associated with the supplier.

FIG. 5 depicts a functional block diagram of the monitor module 410 of FIG. 4. As shown in FIG. 5, monitor module 410 may include camera control logic 510, distance sensor logic 520, product identification logic 530 and inventory alert logic 540. Other configurations may be implemented. Therefore, monitor module 410 may include additional, fewer and/or different components than those depicted in FIG. 5.

Camera control logic 510 may control camera functions in shelf inventory sensor devices 102. Camera control logic 510 may adjust images, pan different views and provide instructions for servomotors to direct the positioning and/or orientation of cameras. Camera control logic 510 may coordinate with user devices 120 and shelf inventory sensor devices 102 to allow suppliers to monitor supermarket shelves visually in real time throughout locations in the networks 130/140.

Distance sensor logic 520 may analyze a distance between the objects and shelf space available. Distance sensor logic 520 may also identify the density of packing of objects (e.g., stacks of cans). Distance sensor logic 520 may control an angle at which the distance sensors are oriented. Distance sensor logic 520 may read distances and coordinate mapping information (e.g., based on a blue print or floor plan) for the allocated space.

Product identification logic 530 may identify particular products based on information such as bar codes or other visual indicia of a product, such as product labeling.

Product identification logic 530 may also identify products based on a size of a product in instances in which the product is obscured by other products (e.g., an inference of a number of cans on the inside of a stack of cans). In these instances, product identification logic 530 may indicate that the number of a particular product is estimated based on the arrangement. In a particular embodiment, product identification logic 530 may review a number of items in instances in which the inventory items 108 are placed on the shelf (e.g., during a stocking process).

Product identification logic 530 may uniquely track each item and determine a duration that each item has been on the shelf. Product identification logic 530 may track items based on real time monitoring and archived footage of the item. Product identification logic 530 may determine with a specific time that a particular item has been on a shelf. Additionally, product identification logic 530 may include a motion sensor and alert camera control logic 510 (if these functions are dormant or at a reduced capacity) and distance sensor logic 520 to collect data in instances in which the items are moved (e.g., at a restocking event).

Inventory alert logic 540 may process shelf inventory sensor data and notify the food manufacturers' systems (and user devices 120) in instances in which a condition for sending a notification is met. For example, inventory alert logic 540 may notify user devices 120 or the manufacturer systems about the inventory level on the shelves when the inventory level for a particular item falls beneath a predetermined threshold. Inventory alert logic 540 may also send alerts in the instance of a restocking event. Additionally, inventory alert logic 540 may send a notification when the utilized volume of the shelf falls below another predetermined threshold.

FIG. 6 is an exemplary functional block diagram of analytics module 420. As shown in FIG. 6, analytics module 420 may include sales data logic 610, inventory trend logic 620 and inventory analysis logic 630. Other configurations may be implemented. Therefore, analytics module 420 may include additional, fewer and/or different components than those depicted in FIG. 6.

Sales data logic 610 may receive sales information from sources associated with retailers, vendors or suppliers, such as cash registers and other point of sale systems and aggregated sales information (e.g., from sales reports and external systems). Sales data logic 610 may compile sales data from external sources (e.g., similar products) and normalize the variables for particular settings (e.g., adjusting for a demographic mix at a particular location, promotional periods, etc.).

Inventory trend logic 620 may generate trend analysis of product availability over a designated time period (e.g., weekly, daily, hourly, etc.) to optimize distribution cost and rented shelf space. Inventory trend logic 620 may enable suppliers to properly restock their products to avoid missed sales opportunities, improve customer retention and reduce distribution cost. Inventory trend logic 620 may perform trend analysis across different demographics and different stores and based on different areas (in the store) in which the shelves are located.

Inventory analysis logic 630 may determine an optimum frequency of delivery and mix of products to maximize particular goals, such as current profit, product or brand penetration, etc. Inventory analysis logic 630 may analyze the movement of inventory based on current inventory movement (e.g., products moved from the shelf in a particular time frame), sales data (such as compiled by sales data logic 610), and historical inventory data. Inventory analysis logic 630 may determine volume of stock and turnover and optimum mix of stock across shelves and incorporate profitability trend analysis. Inventory analysis logic 630 may also perform security functions by comparing stock depletion against sales records.

Inventory analysis logic 630 may provide business analytics to the manufacturers to identify trends and optimize delivery and rented space. Inventory analysis logic 630 may also perform analysis of inventory based on seasonal trends, sales promotions, production, warehouse storage, shipping and other factors outside of retail store activity. For example, inventory analysis logic 630 may perform analytics on marketing initiatives, such as different labeling, etc. inventory analysis logic 630 may determine the relative effectiveness of different packaging, labeling, positioning, etc.

FIG. 7 is an exemplary functional block diagram of dashboard module 430. As shown in FIG. 7, dashboard module 430 may include GUI generation logic 710, live inventory view logic 720 and inventory control tools logic 730. Other configurations may be implemented. Therefore, dashboard module 430 may include additional, fewer and/or different components than those depicted in FIG. 7.

GUI generation logic 710 may include instructions to generate a dashboard in the GUI of user devices 120 associated with suppliers and provide visual components that are used in the dashboard. GUI generation logic 710 may provide multiple items in the dashboard showing product availability that may be accessible through web interfaces and mobile devices (such as user devices 120) authenticated and authorized in association with the supplier. GUI generation logic 710 may provide a capability for user devices 120 to download machine-readable instructions associated with the dashboard application from a service provider network (e.g., via uniform resource locator (URL) or hyperlink, etc.) or inventory management server 110.

Live inventory view logic 720 may coordinate with shelf inventory sensor devices 102 to provide real time pictures of the inventory on shelves to compare with the availability reported by other systems associated with the supplier. Live inventory view logic 720 may display live streams from shelf inventory sensor devices 102 in the dashboard of user devices 120. Live inventory view logic 720 may utilize current truck and shipping schedules to provide projected inventory levels in the dashboard.

Inventory control tools logic 730 may provide tools to analyze inventory and control movement of inventory. Inventory control tools logic 730 may provide a capability to coordinate inventory movement with supplier logistics systems. Inventory control tools logic 730 may transmit instructions to inventory supplier logistics handlers and delivery trucks to coordinate distribution across multiple sales locations over extended times. Inventory control tools logic 730 may determine optimum number of units to be shipped for each product based on analysis and shipping quantities. Inventory control tools logic 730 may also display billing information for the inventory analysis system from the service provider to the supplier.

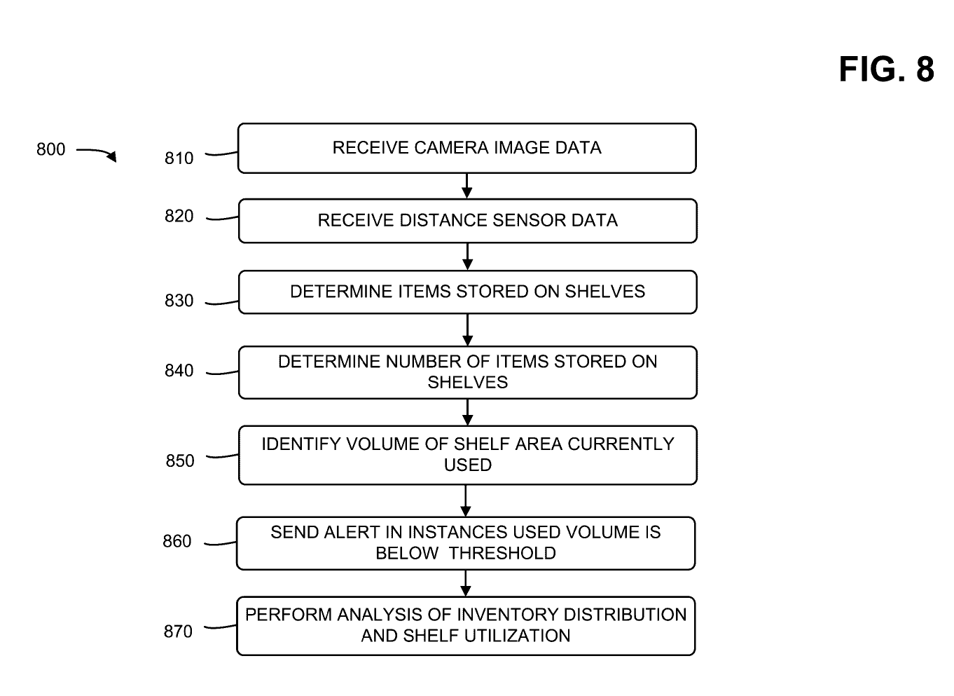

FIG. 8 is a flow chart of an exemplary process for managing inventory based on shelf inventory sensor data from one or more shelf inventory sensor devices 102 according to implementations described herein. In one implementation, process 800 may be performed by Inventory management server 110. In another implementation, some or all of process 800 may be performed by another device or group of devices, including or excluding inventory management server 110.

As shown in FIG. 8, inventory management server 110 may receive camera data from shelf inventory sensor devices 102 (block 810). For example, inventory management server 110 may receive live video feeds from digital cameras in each shelf inventory sensor device 102 that includes views of inventory items 108 stored on shelves. Inventory management server 110 may identify locations of each shelf inventory sensor device 102.

Inventory management server 110 may allow a supplier to visually monitor the inventory by sending video camera data to user devices 120 associated with the supplier for the inventory. Inventory management server 110 may allow the supplier to select between views from different shelf inventory sensor devices 102, and, in some instances, to view and compare stored footage (or statistics) from the shelf inventory sensor devices 102 at different times.

Inventory management server 110 may receive distance sensor data from shelf inventory sensor devices 102 (block 820). For example, inventory management server 110 may receive distance sensor data from distance sensors in each shelf inventory sensor device 102. inventory management server 110 may determine distance between items and the distance sensor and distances between items on the shelf and across the shelf

At block 830, inventory management server 110 may determine items 108 stored on the shelves. For example, inventory management server 110 may access information identifying each of the items stored on the shelves. Inventory management server 110 may compare the images from the shelf inventory sensor devices 102 with a database of information that identifies the items, such as bar codes, images, etc.

At block 840, inventory management server 110 may identify a number of items based on the images viewed from shelf inventory sensor devices 102. For example, inventory management server 110 may analyze a number of items 108 that include particular bar codes. inventory management server 110 may perform spatial analysis based on images to determine (or estimate) a number of items within groups of items 108. The spatial analysis may also be utilized to determine available space for items based on the shapes of prospective items that may be stored in the open space (e.g., based on vertical and horizontal measurement of the space and the object to be stored).

Inventory management server 110 may identify a current used volume of the shelf based on shelf inventory sensor data from the shelf inventory sensor devices 102 (block 850). For example, inventory management server 110 may determine the current used volume based on camera images and distance sensor data. Inventory management server 110 may also determine the total volume of the shelf area.

At block 860, inventory management server 110 may identify instances in which the utilized volume of the shelf area is (or decreases) beneath a threshold volume. For example, inventory management server 110 may receive a value indicating a threshold percentage of the shelf area or minimum occupied shelf area (e.g., input by a supplier via a user device 120, predetermined, etc.). Inventory management server 110 may compare the current utilized shelf area versus the value or predetermined threshold and provide an alert to user devices 120 associated with the supplier in instances in which the volume is beneath the threshold.

Inventory management server 110 may send a notification to user device 120 associated with the supplier of inventory items 108 in instances in which a volume of a particular item (or group of items) falls beneath a threshold. Inventory management server 110 may also provide alerts when items stored at the shelf spaces are not associated with the supplier (e.g., in instances in which a competitor's product is stored in the shelf space).

Inventory management server 110 may perform analysis of inventory distribution and shelf utilization (block 870). For example, identify support analysis of inventory items 108 on user devices 120. Inventory management server 110 may support analysis by the supplier of inventory movement based on historical values and computations of profitability across multiple locations and product types.

Systems and/or methods described herein may allow monitoring of inventory on retail and storage shelves and allow the inventory suppliers to analyze inventory movement, distribution and sales and to maximize the utilization of allocated retail spaces.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. For example, while series of blocks have been described with respect to FIG. 8, the order of the blocks may be modified in other implementations. Further, non-dependent blocks may be performed in parallel.

It will be apparent that different aspects of the description provided above may be implemented in many different forms of machine-readable instructions, firmware, and hardware in the implementations illustrated in the figures. The actual machine-readable instructions or specialized control hardware used to implement these aspects is not limiting of the invention. Thus, the operation and behavior of these aspects were described without reference to the specific machine-readable instructions—it being understood that machine-readable instructions and control hardware can be designed to implement these aspects based on the description herein.

Further, certain portions of the invention may be implemented as a “component” or “system” that performs one or more functions. These components/systems may include hardware, such as a processor, an ASIC, or a FPGA, or a combination of hardware and machine-readable instructions.

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, act, or instruction used in the present application should be construed as critical or essential to the invention unless explicitly described as such. Also, as used herein, the article “a” and “one of” is intended to include one or more items. Further, the phrase “based on” is intended to mean “based, at least in part, on” unless explicitly stated otherwise.

What is claimed is:

1. A computer-implemented method, comprising:
receiving, at an inventory monitoring device and from a system that includes at least one shelf inventory sensor device that includes at least one camera and at least one distance sensor positioned to monitor at least one shelf space, camera image data from the at least one shelf inventory sensor device;
receiving, at the inventory monitoring device, distance sensor data from the at least one shelf inventory sensor device;
determining items stored on the at least one shelf space based on the camera image data;
determining a number of items stored on the at least one shelf space based on the camera image data;
identifying a current used volume of the at least one shelf space based on the distance sensor data; and
sending a notification to a device associated with the supplier in response to determining that the current used volume is lower than a predetermined threshold.

2. The computer-implemented method of claim 1, further comprising:
performing trend analysis of inventory distribution associated with the supplier on the device associated with the supplier.

3. The computer-implemented method of claim 1, further comprising:
receiving at least one video stream from the at least one shelf inventory sensor device; and
providing the at least one video stream from the at least one shelf inventory sensor device to the device associated with the supplier.

4. The computer-implemented method of claim 3, wherein the at least one video stream comprises a plurality of video streams and providing the plurality of video streams further comprises:
allowing selection between different video streams based on input provided by the supplier.

5. The computer-implemented method of claim 3, further comprising:
receiving a temperature of the at least one shelf space from the at least one shelf inventory sensor device; and
providing the temperature of the at least one shelf space to the device associated with the supplier.

6. The computer-implemented method of claim 3, further comprising:
receiving a duration that an item is stored on the at least one shelf space from the at least one shelf inventory sensor device; and
providing the duration that the item is stored on the at least one shelf space to the device associated with the supplier.

7. The computer-implemented method of claim 3, further comprising:
determining at least one of a bar code or product description associated with an item to stored on the at least one shelf space; and
providing the at least one of a bar code or product description to the device associated with the supplier.

8. The computer-implemented method of claim 1, wherein sending a notification to the device associated with the supplier further comprises:
sending the notification in response to a number of a particular item decreasing below a threshold.

9. The computer-implemented method of claim 1, wherein sending a notification to the device associated with the supplier further comprises:
sending the notification in response to detecting items in the at least one shelf space not associated with the supplier.

10. The computer-implemented method of claim 1, further comprising:
providing an interface between a dashboard application on the at least one user device and at least one system associated with a supplier to schedule and route shipments.

11. The computer-implemented method of claim 1, wherein the at least one inventory sensor device comprises a plurality of inventory sensor devices arranged in a shelf inventory monitoring strip including a shelf controller device that reads the camera image data and the distance sensor data from the plurality of inventory sensor devices.

12. A device comprising:
a memory to store a plurality of instructions; and
a processor configured to execute instructions in the memory to:
receive, from a system that includes at least one shelf inventory sensor device that includes at least one camera and at least one distance sensor positioned to monitor at least one shelf space, camera image data from the at least one shelf inventory sensor device;
receive distance sensor data from the at least one shelf inventory sensor device;
determine items stored on the at least one shelf space based on the camera image data;
determine a number of items stored on the at least one shelf space based on the camera image data;
identify a current used volume of the at least one shelf space based on the distance sensor data; and
send a notification to a device associated with the supplier in response to determining that the current used volume is lower than a predetermined threshold.

13. The device of claim 12, wherein the processor is further configured to:
perform trend analysis of inventory distribution associated with the supplier on the device associated with the supplier.

14. The device of claim 12, wherein the processor is further configured to:
receive at least one video stream from the at least one shelf inventory sensor device; and
provide the at least one video stream from the at least one shelf inventory sensor device to the device associated with the supplier.

15. The device of claim 14, wherein the at least one video stream comprises a plurality of video streams and when providing the plurality of video streams the processor is further configured to:
allow selection between different video streams based on input provided by the supplier.

16. The device of claim 14, wherein the processor is further configured to:
receive a temperature of the at least one shelf space from the at least one shelf inventory sensor device; and
provide the temperature of the at least one shelf space to the device associated with the supplier.

17. The device of claim 14, wherein the processor is further configured to:
receive a duration that an item is stored on the at least one shelf space from the at least one shelf inventory sensor device; and
provide the duration that the item is stored on the at least one shelf space to the device associated with the supplier.

18. The device of claim 14, wherein, when sending a notification to the device associated with the supplier, the processor is further configured to:
send the notification in response to a number of a particular item decreasing below a threshold.

19. A computer-readable medium including instructions to be executed by a processor, the instructions including one or more instructions, when executed by the processor, for causing the processor to:
receive, from a system including at least one shelf inventory sensor device that each includes at least one camera and at least one distance sensor positioned to monitor at least one shelf space, camera image data from the plurality of at least one shelf inventory sensor device;
receive distance sensor data from the plurality of at least one shelf inventory sensor device;
determine items stored on the at least one shelf space based on the camera image data;
determine a number of items stored on the at least one shelf space based on the camera image data;
identify a current used volume of the at least one shelf space based on the distance sensor data; and
send a notification to a device associated with the supplier in response to determining that the current used volume is lower than a predetermined threshold.

20. The computer-readable medium of claim 19, wherein, when sending a notification to the device associated with the supplier, the one or more instructions further includes instructions to:
send the notification in response to detecting items in the at least one shelf space not associated with the supplier.
